(19) United States
(12) Patent Application Publication
(10) Pub. No.: US 2008/0138631 A1
(43) Pub. Date: Jun. 12, 2008

(54) METHOD TO REDUCE MECHANICAL WEAR OF IMMERSION LITHOGRAPHY APPARATUS

(75) Inventors: Kaushal S. Patel, Wappingers Falls, NY (US); Daniel A. Corliss, Hopewell Junction, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/567,394

(22) Filed: Dec. 6, 2006

(51) Int. Cl. B32B 9/00

(52) U.S. Cl. 428/427; 428/688; 428/698

(57) ABSTRACT

A protective coating is provided for components of an immersion lithography tool, in which at least a portion of a component exposed to the immersion fluid is protected by a thin, hard protective coating, comprising materials such as silicon carbide, diamond, diamond-like carbon, boron nitride, boron carbide, tungsten carbide, aluminum oxide, sapphire, titanium nitride, titanium carbonitride, titanium aluminum nitride and titanium carbide. The protective coating may be formed by methods such as CVD, PECVD, APCVD, LPCVD, LECVD, PVD, thin-film evaporation, sputtering, and thermal annealing in the presence of a gas. The protective coating preferably has a hardness greater than a Knoop hardness of about 1000 and more preferably greater than about 2000, or a Moh hardness greater than about 7, more preferably greater than about 9. The protective coating minimizes defects due to mechanical wear of scanner components.

### FIELD OF THE INVENTION

The present invention relates to the manufacture of integrated circuits and an apparatus and method for reducing defects and improving durability of equipment used in the manufacture of integrated circuits. More particularly, the present invention relates to an apparatus and method for reducing mechanical wear of components in an immersion lithography apparatus.

### BACKGROUND OF THE INVENTION

Liquid immersion lithography has emerged as the leading candidate for sub-wavelength, optical patterning of advanced integrated circuits. By filling the gap between the last lens element of the optical projection system and the surface of the wafer with a high refractive index fluid, optical projection systems having numerical aperture (NA) approaching the refractive index of the fluid are possible. High numerical aperture enables increased resolution which is essential for improving performance of integrated circuits. The high refractive index fluid used in this manner is commonly referred to as the immersion fluid.

One method for introducing the immersion fluid between the last lens element and the surface of the wafer is by the use of a local fluid handling and confinement module commonly referred to as the immersion head or showerhead, which is attached to the bottom of the optical projection system assembly described in prior art attached herewith. This approach has been applied by several commercial suppliers in their designs of full field, step-and scan tools (or scanners) for high throughput manufacturing. A schematic of the showerhead 4 in relation to the wafer 3 and the wafer table 2 is illustrated in FIG. 1A. Some scanner designs may even provide multiple wafer tables to enable faster wafer throughput. The showerhead 4 encloses the last lens element 1 of the optical projection system to allow localized fluid 5 filling of the area between the lens 1 and the wafer 3. The wafer 3 is placed in a recess in the wafer table 2, such that the top surface of the wafer 3, which is coated with a photoresist layer 10, is substantially coplanar to the surface of the wafer table 2 to minimize conflict with the showerhead 4 and minimize disturbance to the flow of the fluid 5 as the wafer table 2 is in motion beneath the showerhead 4. While the scanner is operational, the fluid 5 is continuously replenished and circulated in the showerhead 4 to prevent particles or chemical contaminants from concentrating or to provide a difficult environment for bacteria growth in the fluid 5. Particles, chemical contaminants or bacteria are undesirable as they can potentially deposit onto the surface of the wafer 3 causing defects. The wafer table 2 may also possess other elements such as a wafer alignment and leveling sensors 8 which are similarly designed to minimize conflict with the showerhead 4 and the flow of fluid 5. Additional elements, such as a closing disk 7 or closing plate, may also be introduced to the scanner design to limit fluid leakage and spill-over during wafer exchange. The purpose of the closing disk is to seal the fluid 5 in the showerhead 4 and prevent leakage when the scanner is idle and not processing a wafer. The closing disk 7 allows the fluid 5 to continue to circulate in the showerhead 4 thus reducing chances of defects. When the showerhead 4 is processing a wafer, the closing disk 7 may rest in a closing disk receptacle 6 which may be a recessed cavity in the wafer table 2. To seal the showerhead 5 the closing disk 7 is picked up by the showerhead 4 and held in place using vacuum, magnetic or other means as illustrated in FIG. 1B. This “lift” operation could further be assisted by pushing the closing disk 7 from its receptacle 6 towards the showerhead 4 through the use of actuators, mechanical or otherwise. When the showerhead 5 is ready to process a wafer the “lift” operation is reversed and the closing disk 7 is placed into the closing disk receptacle 6 by the showerhead 4 thus performing a “drop” operation. To minimize interference with the showerhead 4 and flow of fluid 5, the closing disk 7 must remain flush with the wafer table 2 and should not be resting on any edge of the closing disk receptacle 6. The closing disk 7 may be held in place in the closing disk receptacle 6 by mechanical, magnetic means or otherwise.

In order to ensure the closing disk 7 forms a good seal with the showerhead 4 during the “lift” operation as well as ensure it is placed correctly into the closing disk receptacle 6 during the “drop” operation it may become necessary to maintain alignment between the closing disk receptacle 6 with the showerhead 4. This may be accomplished through mechanical or optical methods. One method for optically aligning the closing disk receptacle 6 to the showerhead 4 is by projecting a beam of radiation through the optical projection system, through the showerhead assembly 4, through the closing disk 7 onto the wafer table 2. The wafer table 2 is then moved until the closing disk receptacle 6 is directly beneath the showerhead 4 which is determined by sensing the beam of radiation in the closing disk receptacle 6. For this approach to work, the closing disk 7 must be optically transparent to the beam of radiation which may be an excimer laser of certain wavelength. Typical excimer laser used in integrated circuit manufacture include KrF excimer laser (248 nm), ArF excimer laser (193 nm) and F₂ excimer laser (157 nm). An example of a materials used to construct the closing disk 7 is quartz which is optically transparent to radiation of wavelength 193 nm and is commonly used in optical lens elements in ArF scanners. The closing disk 7 may further possess an alignment pattern 13 on its surface to assist with the optical alignment as illustrated in FIG. 2. The alignment pattern 13 is preferably comprised of a material 12 which is different from the substrate material 11 of the closing disk 7. The alignment pattern 13 may also have any shape most suitable for optical alignment and would selectively allow the incident beam of radiation to pass through. Materials and processes most commonly used to manufacture masks for optical lithography are suitable for producing the alignment pattern and are known to those skilled in the art. For example, an alignment pattern formed in a chromium layer may be applied onto one side of a quartz closing disk substrate.

In the case where the closing disk receptacle 6 is mechanically aligned to the showerhead 4, optical transparency of the closing disk 7 is not a requirement.

Instead of a closing disk design, a closing plate mechanism independent of the wafer table 2 could also be utilized to seal the fluid 5 in the showerhead 4. The function of the closing plate remains similar to the function of a closing disk 7.

One of the primary challenges with immersion lithography is reducing defects. Particles deposited on the imaging surface during the scanning process can lead to reduced yield performance. The photoresist layer 10, the immersion fluid 5 and the other elements of the scanner such as the showerhead 4, the closing disk 7, closing plate or wafer alignment and leveling sensors 8 are all potential sources of contamination. Scanner elements can become particle generators due to mechanical wear or through chemical interaction with the immersion fluid 5. In the closing disk design, mechanical wear can occur during the showerhead 4 sealing operation when the closing disk 7 comes into contact with the showerhead 4 which is typically fabricated in metal such as stainless steel or when the closing disk 7 is replaced in the closing disk receptacle 6 which is fabricated into the wafer table 2. Upon repetitive use the surface and defined edges of the closing disk 7, closing disk receptacle 6, and the showerhead 4 may experience mechanical wear and abrade to generate particles which could potentially enter into the immersion fluid, be deposited onto the wafers and subsequently cause particle induced imaging defects. To reduce the mechanical wear sharp edges of these elements may be defined or chamfered, however, mechanical polishing to create the defined edge can create fracture points which may wear and generate particles after repetitive use. Mechanical polishing of surfaces to attain nanometer-scale flatness may also induce similar fracture points. Quartz closing disks are particularly susceptible to damage by mechanical abrasion due to their moderate hardness (Moh hardness value of 7). Closing disks made from other ceramic materials, such as Zerodur® (from SCHOTT Corporation), may improve on the quartz with regards to hardness but their benefits in terms of defect reduction are unproven. Thermal treatments to fuse the contact surfaces and improve the mechanical durability of such coatings would deform the intended mechanical shape and tolerance of the closing disk and hence is also not preferred. Finally, mechanical wear of the closing disk 7 can occur for either mechanical or optical alignment designs.

Further, continuous contact with the immersion fluid 5 could potentially dissolve or etch some of the surface material from the closing disk substrate 11, the closing disk alignment material 12, the showerhead 4 and other scanner elements which could then be deposited onto the wafer 3 also causing contamination. Energetic free radicals generated in the immersion fluid upon irradiation can further enhance this chemical erosion.

One solution to protect the closing disk from damage may be to coat it with a protective coating. Common coatings utilized in the field of optics, such as oxides or fluorides, however, cannot be utilized since they tend to be brittle and are easily damaged.

Thus, there is a need an apparatus and method for performing immersion lithography which includes scanner components which have increased resistance to mechanical or chemical wear thereby reducing imaging defects.

### SUMMARY OF THE INVENTION

Bearing in mind the problems and deficiencies of the prior art, it is therefore an object of the present invention to provide components of an immersion lithography system that will minimize defects due to mechanical wear.

A further objective of the present invention is to seal the showerhead of an immersion lithography system between wafer exposures while minimizing mechanical wear of the showerhead.

A further objective of the present invention is to provide a closing disk for sealing an immersion lithography system that is resistant to mechanical wear and minimize defect causing particles and contaminants from entering the immersion fluid.

The above and other objects, which will be apparent to those skilled in the art, are achieved in the present invention, which is directed to an article of manufacture for use in immersion lithography, the article of manufacture comprising:
a. a first component comprising a first component body and a protective coating comprising at least one layer on at least a portion of said first component body, wherein said first component is configured in an immersion lithography tool such that said portion of said first component body may contact immersion fluid during operation of said immersion lithography tool, and wherein said protective coating has a hardness greater than that of quartz.

According to one embodiment, this invention provides a thin protective coating material on a closing disk and showerhead of an immersion lithography system.

According to another aspect of the invention, the protective coating may comprise multiple layers of different materials. The protective coating is preferably thin, and may be formed from materials including silicon carbide, diamond, diamond-like carbon, boron nitride, boron carbide, tungsten carbide, aluminum oxide, sapphire, titanium nitride, titanium carbonitride, titanium aluminum nitride and titanium carbide.

The protective coating may be formed by methods such as CVD, PECVD, APCVD, LPCVD, LECVD, PVD, thin-film evaporation, sputtering, and thermal annealing in the presence of a gas. The protective coating is preferably chemically inert to the immersion fluid. The protective coating preferably has a hardness greater than a Knoop hardness of about 1000 and more preferably greater than about 2000, or a Moh hardness greater than about 7, more preferably greater than about 9.

Still other objects and advantages of the invention will in part be obvious and will in part be apparent from the detailed description.

### BRIEF DESCRIPTION OF THE DRAWINGS

FIG. 1A is a schematic illustration showing the various elements of a prior art immersion lithography apparatus including a shower head positioned over a wafer.

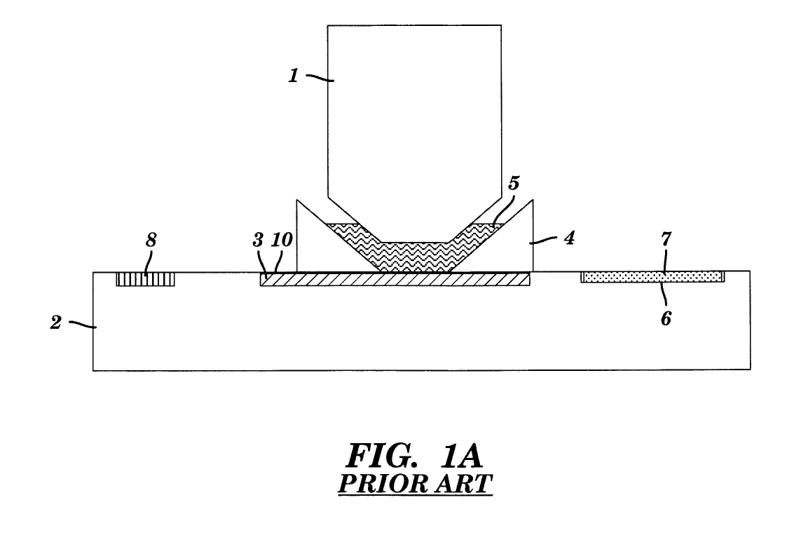

FIG. 1B is a schematic illustration of a prior art immersion lithography apparatus including a shower head sealed by a closing disk.

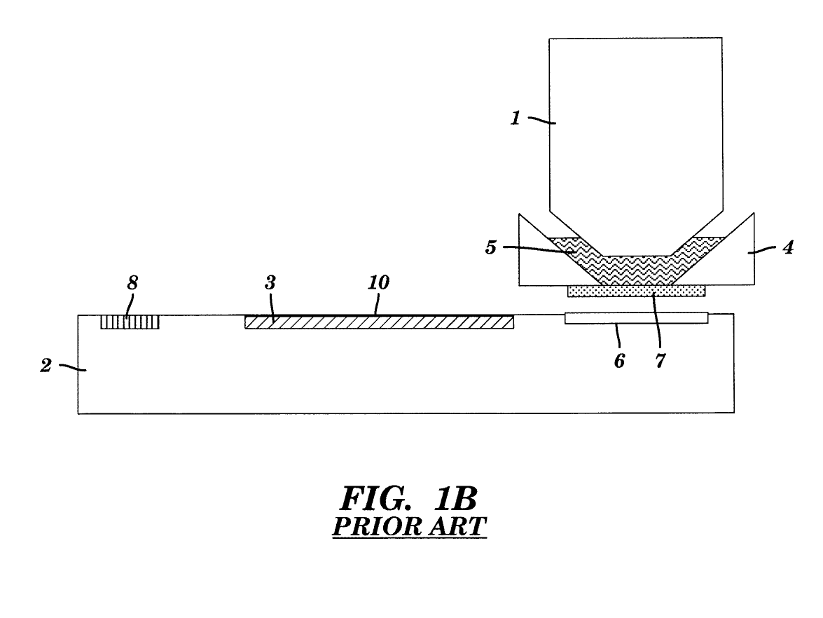

FIG. 2 is a schematic illustration of a prior art closing disk in cross-section and in plan view.

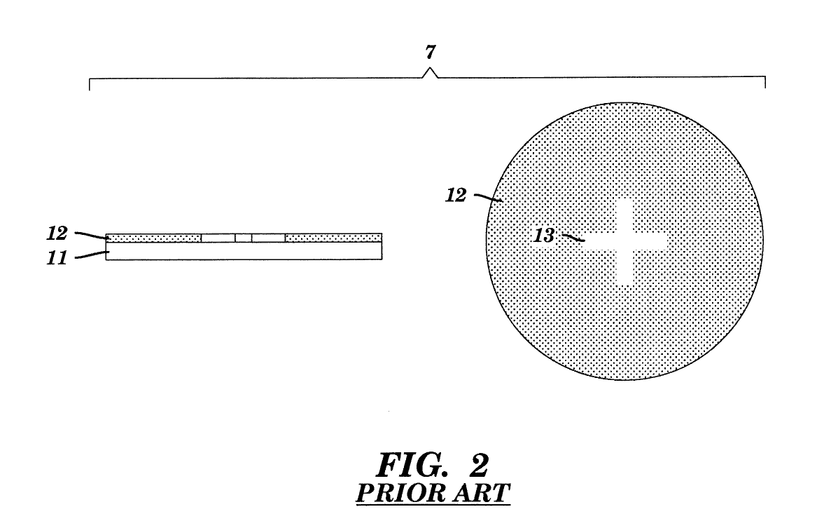

FIGS. 3A-3C are schematic illustrations of coated closing disks according to embodiments of the invention.

FIG. 4 illustrates a cross-section and a top down view of a coated closing disks according to another embodiment of the present invention.

### DETAILED DESCRIPTION OF THE INVENTION

The present invention will now be described in greater detail by referring to the following discussion with reference to the drawings that accompany the present application. It is observed that the drawings of the present application are provided for illustrative purposes and thus they are not drawn to scale.

In accordance with the present invention, a thin, protective, single- or multi-layer coating is provided on the surface of components of an immersion lithography scanner, in particular, where such components may contact other components as well as contact the immersion fluid. For example, the protective coating may be provided on a showerhead, the closing disk or the closing disk receptacle in the wafer stage to reduce wear of the components due to mechanical contact during operation.

The protective coating is preferably sufficiently thin so as to maintain the surface finish, flatness and mechanical tolerances of components, such as between a closing disk and the showerhead assembly or the closing disk and the closing disk receptacle. The protective coating preferably comprises less than five layers of one or more material compositions and more preferably less than 2 layers and most preferably a single layer. Each of the layers in the protective coating may range in thickness from about 1 nanometer to about 150 micrometers, more preferably between about 5 nanometers and about 50 micrometers, and most preferably between 10 nanometers and 10 micrometers. Each of the layers in the protective coating is preferably of homogenous composition and has a uniform thickness across the coated surface. For example, a quartz closing disk may be coated with a layer of silicon carbide, diamond-like carbon (DLC) or diamond film. Examples of other coating materials include diamond films, diamond-like carbon (DLC) films, boron nitride, boron carbide, silicon carbide, tungsten carbide, aluminum oxide, sapphire, titanium nitride, titanium carbonitride, titanium aluminum nitride and titanium carbide films.

The layers of material comprising the protective coating are preferably deposited by chemical vapor deposition (CVD) due to the relative low cost of the method and the ability of CVD methods to produce a large variety of films and coatings of controlled stoichiometry. Variants of CVD processing may include plasma enhanced (PECVD), atmospheric pressure (APCVD), low-pressure (LPCVD), laser-enhanced (LECVD) chemical vapor deposition. Other deposition methods may be used by themselves or in combination, including, but not limited to, physical vapor deposition methods (PVD) such as thin-film evaporation or sputtering. The inventive hard protective coating may also be grown by thermal annealing in presence of a gas, for example, for growing titanium nitride on surface of titanium by thermal annealing in presence of nitrogen. Any method now known or developed in the future for depositing or forming a protective coating is contemplated within the scope of the invention, and the invention is not limited by the methods listed herein.

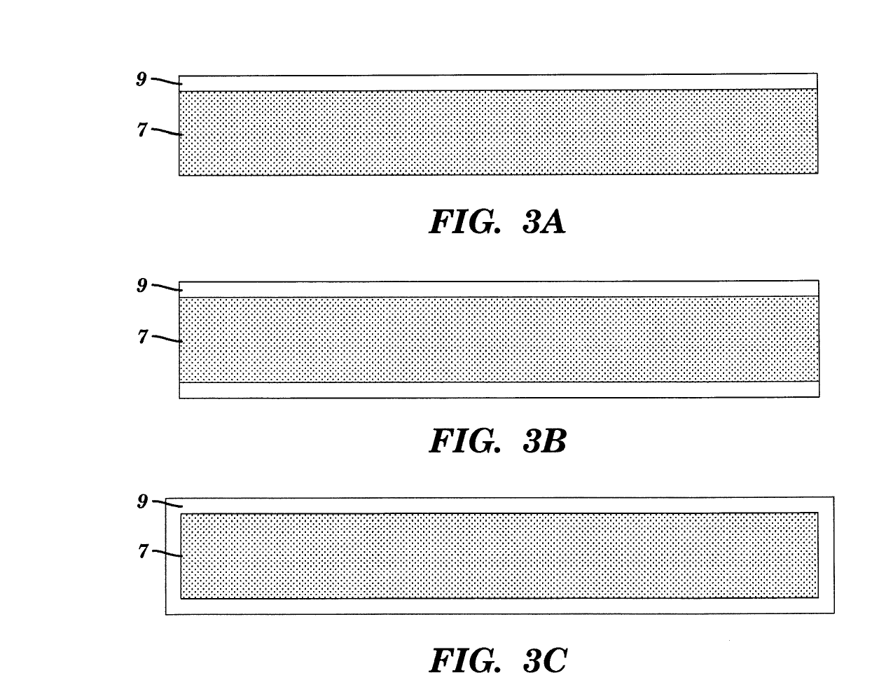

The protective coating 9 may selectively cover a portion of the surface of the component to be protected (FIG. 3A), several discrete or connected portions of the component surface (FIG. 3B), or completely encapsulate the component (FIG. 3C). For example, in the case of the closing disk it may be preferred to encapsulate the entire disk with the protective coating. In the case of the showerhead it may be preferred to only coat the surfaces which come into contact with the closing disk during operation.

The protective coating must adhere to the base materials, which may be metallic, non-metallic, ceramic or a composite. Examples of base materials used to construct the components in the immersion lithography apparatus include stainless steel, titanium, Zerodur® glass ceramic or quartz.

The protective coating must have low surface roughness to prevent scattering of the incident light, to reduce friction during contact between components, and where necessary to form a good seal against immersion fluid penetration between the surfaces it contacts. Preferably the root mean square surface roughness, as measured using an Atomic Force Microscope (AFM), must be less than 50 nanometers, more preferably less than 25 nanometers, and most preferably less than 5 nanometers. For some coatings, smoothing to reduce the surface roughness may be necessary after the films are deposited, for example, by mechanical polishing or thermal annealing.

The protective coating surface is preferably non-wetting to the immersion fluid to further prevent immersion fluid penetration between contacting surfaces.

Each layer of the protective coating and the overall coating is preferably defect-free. Defects may arise due to localized variation in thickness of the individual layers, pin-holes or inclusions in the individual layers or the coating, or de-lamination between layers or between the coating and the base substrate. Since de-lamination can occur due to internal stress build-up in the coating, alternate layers in the coating may possess varying mechanical properties. For example, a multi-layer coating on a titanium base substrate may comprise films of titanium nitride, titanium carbonitride, titanium carbide and diamond-like carbon (DLC). An example of a multi-layer coating on a quartz base substrate may comprise films of silicon carbide and diamond-like carbon (DLC).

The protective coating preferably has a high Knoop hardness greater than 1000 and more preferably greater than 2000. Alternately the coating has preferably a Moh hardness greater than 7 and more preferably greater than 9. Coatings with high hardness tend to also be wear-resistant which is beneficial to minimize mechanical wear. Examples of material films exhibiting such hardness includes diamond films, diamond-like carbon (DLC) films, boron nitride, boron carbide, silicon carbide, tungsten carbide, aluminum oxide, sapphire, titanium nitride, titanium carbonitride, titanium aluminum nitride and titanium carbide films.

The protective coating preferably has high mechanical strength, having a Young's modulus of greater than 100 GPa and more preferably greater than 200 GPa.

The protective coating has a low dry coefficient of friction in the range of 0 to 0.4 and more preferably in the range 0 to 0.2. A low coefficient of friction is preferred as it would reduce the friction forces exerted on the closing disk when it slides against the immersion disk or the closing disk cavity. This is turn reduces the wear experienced by the closing disk thus improving its durability. Examples of materials with low coefficient of friction include diamond films and diamond-like carbon films.

In some cases it may be preferential to coat similar films on the opposing surfaces to control the friction between the surfaces or control the relative hardness of the two surfaces. For example, the coefficient of friction between two diamond-like carbon surfaces will be lower than the coefficient of friction between a diamond-like carbon surface and a metal surface. Similarly, since the relative hardness of a diamond-like carbon surface is greater than the hardness of a metal surface, contact between such opposing surfaces may result in increased wear of the metal surface. If both surfaces are coated with similar material then wear would be minimized.

The protective coating is preferably substantially chemically inert to the immersion fluid, which may include any free radicals, oxidizing, acidic or alkaline compounds that may be generated in the immersion fluid upon irradiation or that may have leached into the immersion fluid upon contact with the photoresist on the wafer. The protective coating must also be substantially chemically inert to any other fluid that may be circulated through the showerhead such as a optical lens cleaning solution. Such reactions may generate defects or contaminants. The protective coating is preferably substantially inert with respect to such an immersion fluid over the useful lifetime of the tool, so as to avoid tool down time. Diamond or diamond-like carbon films are examples of coatings which are chemically inert towards a wide range of chemicals.

The protective coating preferably has thermal expansion characteristics substantially equal to the base substrate material to reduce the risk of de-lamination due to internal stresses. A larger mismatch in linear coefficient of thermal expansion (a) between the protective coating and the base substrate material will result in larger internal stress in the coating. This preference is more necessary if the protective coating is deposited at temperature much greater than the temperature at which the immersion scanner operates. For example, the linear coefficient of thermal expansion of a diamond film (α=1×10⁻⁶/Kelvin) is very similar to that of a quartz (α=0.6×10⁻⁶/Kelvin) or a glass ceramic, such as a Zerodur® (α=˜0/Kelvin) substrate. Thus, a diamond film would be highly preferred as a coating material for a quartz or glass ceramic substrate.

The protective coating preferably is optically transparent to the radiation employed in the optical projection system when applied to portions of components which must transmit the radiation. An example of such a component is the closing disk when used in conjunction with an optical alignment method. If the protective coating material absorbs a portion of the incident radiation and attenuates it, the thickness of the protective coating must be reduced to enhance the transmission. In this manner the mechanical durability and wear resistance of the coated component is improved without significantly diminishing its optical transparency to incident radiation thereby eliminating the need to identify new optically transparent, wear resistant material for fabricating the closing disk substrate. In accordance with the present invention, such a thin protective coating can be applied on the optical components of the scanner to improve durability without compromising optical transparency at minimal modification and cost. An example of such a material is a coating of diamond or diamond-like carbon film having thickness less than 1 micrometer.

When the protective coating is selectivity applied to portions of the optical component which are not in the optical pathway then optical transparency is not a requirement for such a coating.

Unlike prior art coatings on optical elements, which coatings tend to emphasize optical properties, the films according to the present invention emphasize mechanical durability of the film. In accordance with the invention, optical transparency of the film to the alignment laser may be beneficial, but is not required. In case the coating is highly absorbing, it may be coated on all surfaces except the alignment window where transmission of light is important.

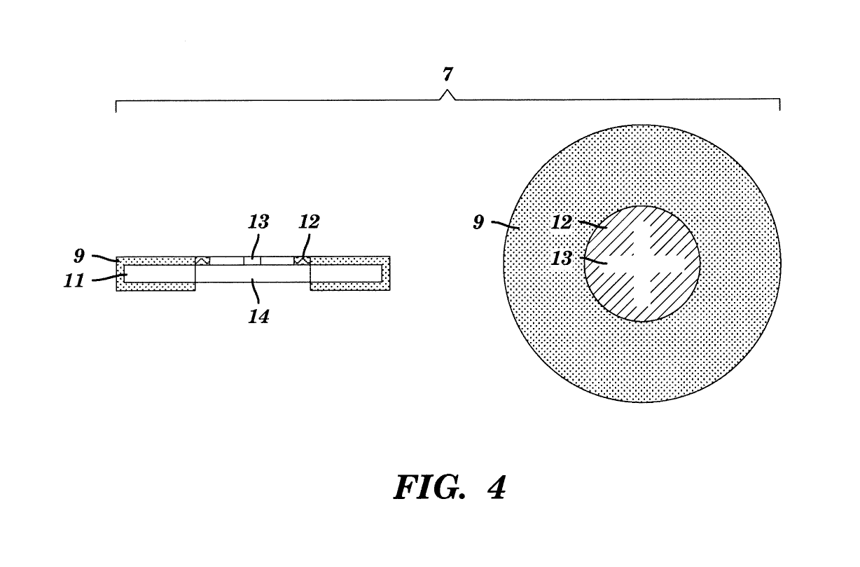

In accordance with the invention, an optical element such as a closing disk may be constructed by mounting a optical transparent alignment window 14 in a frame 11 constructed from a wear resistant material or coated with a wear resistant protective coating 9 as illustrated in FIG. 4.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. An article of manufacture for use in immersion lithography, the article of manufacture comprising:
a first component comprising a first component body and a protective coating comprising at least one layer on at least a portion of said first component body, wherein said first component is configured in an immersion lithography tool such that said portion of said first component body may contact immersion fluid during operation of said immersion lithography tool, and wherein said protective coating has a hardness greater than that of quartz.

2. The article of manufacture of claim 1, wherein said at least one layer comprises a material selected from the group consisting of silicon carbide, diamond, diamond-like carbon, boron nitride, boron carbide, tungsten carbide, aluminum oxide, sapphire, titanium nitride, titanium carbonitride, titanium aluminum nitride and titanium carbide.

3. The article of manufacture of claim 1, wherein said protective coating comprises five or fewer layers.

4. The article of manufacture of claim 1, wherein said protective coating comprises a plurality of layers comprising different materials.

5. The article of manufacture of claim 1, wherein said protective coating has a thickness less than about 150 micrometers.

6. The article of manufacture of claim 1, wherein said protective coating is substantially inert to said immersion fluid.

7. The article of manufacture of claim 3, wherein at least one of said layers is formed by a method selected from the group consisting of CVD, PECVD, APCVD, LPCVD, LECVD, PVD, thin-film evaporation, sputtering, and thermal annealing in the presence of a gas.

8. The article of manufacture of claim 1, wherein said first component is configured in said immersion lithography tool such that said portion of said first component body may contact a portion of a second component body, wherein said portion of said second body comprises a second protective coating comprising the same material as said protective coating.

9. The article of manufacture of claim 1, wherein said first component is selected from the group consisting of a closing disk, a shower head, a closing disk receptacle and an optical component.

10. The article of manufacture of claim 1, wherein said protective coating has a surface roughness less than 50 nm, as measured using an atomic force microscope.

11. The article of manufacture of claim 1, wherein said protective coating has a Young's modulus greater than about 100 GPa.

12. The article of manufacture of claim 1, wherein said protective coating has a Knoop hardness greater than about 1000.

13. The article of manufacture of claim 1, wherein said protective coating has a Moh hardness greater than 7.

14. The article of manufacture of claim 1, wherein said protective coating has a dry coefficient of friction in the range of 0 to 0.4.

15. The article of manufacture of claim 1, wherein said protective coating has a linear coefficient of expansion substantially similar to the linear coefficient of expansion of said first component body.

16. The article of manufacture of claim 1, wherein said protective coating is optically transparent to the radiation employed in said immersion lithography tool.

17. The article of manufacture of claim 1, wherein said first component is an optical component, and said protective coating is applied to portions of said optical component that are not in the optical pathway of said optical component.

18. The article of manufacture of claim 1, wherein said first component comprises a material selected from the group consisting of quartz and glass ceramic.

19. The article of manufacture of claim 18, wherein said protective coating comprises a diamond-like carbon film.

20. The article of manufacture of claim 1, wherein said protective coating is non-wetting to the immersion fluid.
